(19) United States
(12) Patent Application Publication
(10) Pub. No.: US 2022/0351643 A1
(43) Pub. Date: Nov. 3, 2022

(54) Smoke Detection Assembly

(71) Applicant: Robert Lucas, Cleveland, OH (US)

(72) Inventor: Robert Lucas, Cleveland, OH (US)

(21) Appl. No.: 17/242,901

(22) Filed: Apr. 28, 2021

(51) Int. Cl. G09F 3/00; G01N 21/78

(52) U.S. Cl. CPC G09F 3/0291; G01N 21/783; G09F 2003/023

(57) ABSTRACT

A smoke detection assembly for indicating when organic material has been smoked in an area includes a decal that has an adhesive layer is integrated such that the decal can be adhered to a surface in a cab of a vehicle. A chemical reagent is provided and the chemical reagent is infused into the decal. The chemical reagent is chemically reactive with one or more chemicals that are unique to smoke from combustion of organic material. Moreover, the chemical reagent changes colors when the chemical reagent is exposed to airborne nicotine. In this way the chemical reagent can visually indicate when organic material has been smoked in the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to detection devices and more particularly pertains to a new detection device for indicating when organic material has been smoked in an area. The detection device changes color when the detection device is exposed to airborne smoke.

### (2) Description of Related Art Including Information Disclosed Under 37 CFR 1.97 and 1.98

The prior art relates to detection devices including a thermally reactive panel that visually responds to heat to indicate when a smoking product, such as organic material, has been smoked. The prior art discloses a lateral flow test strip for testing for nicotine in an area.

### BRIEF SUMMARY OF THE INVENTION

An embodiment of the disclosure meets the needs presented above by generally comprising a decal that has an adhesive layer is integrated such that the decal can be adhered to a windshield in a cab of a vehicle. A chemical reagent is provided and the chemical reagent is infused into the decal. The chemical reagent is chemically reactive with one or more chemicals that are unique to smoke from combustion of organic material. Moreover, the chemical reagent changes colors when the chemical reagent is exposed to airborne smoke. In this way the chemical reagent can visually indicate when an organic material, such as tobacco, marijuana, cocaine or any other type of smoke-able drug, has been smoked in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a smoke detection assembly according to an embodiment of the disclosure.

FIG. 2 is a front view of an embodiment of the disclosure showing a chemical reagent changing color.

FIG. 3 is a cross sectional view taken along line 3-3 of FIG. 1 of an embodiment of the disclosure.

FIG. 4 is a perspective in-use view of an embodiment of the disclosure.

FIG. 5 is an interior in-use view of an embodiment of the disclosure.

### DETAILED DESCRIPTION OF THE INVENTION

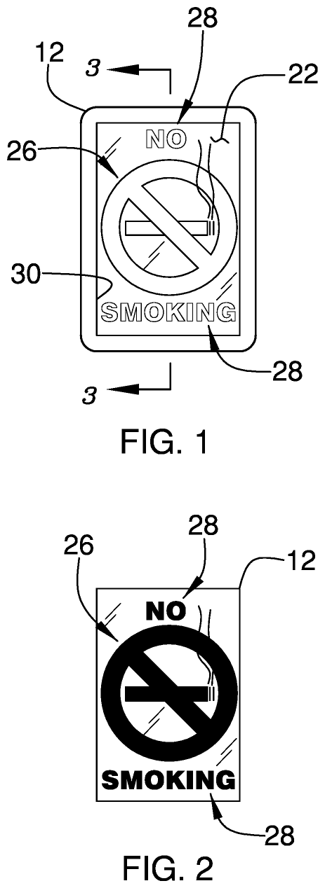

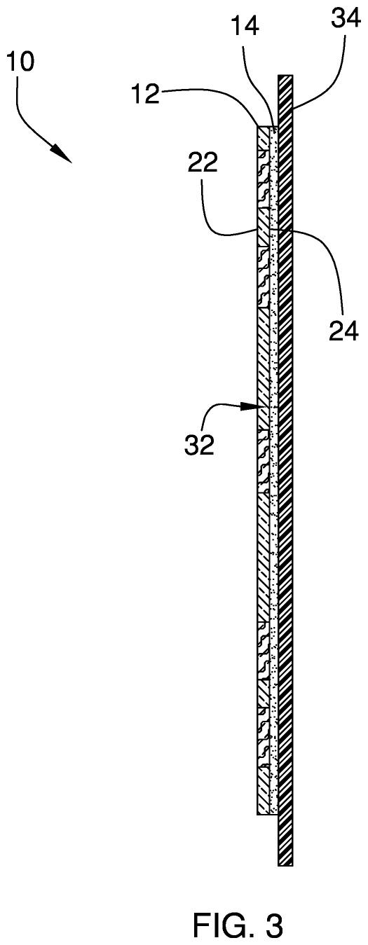

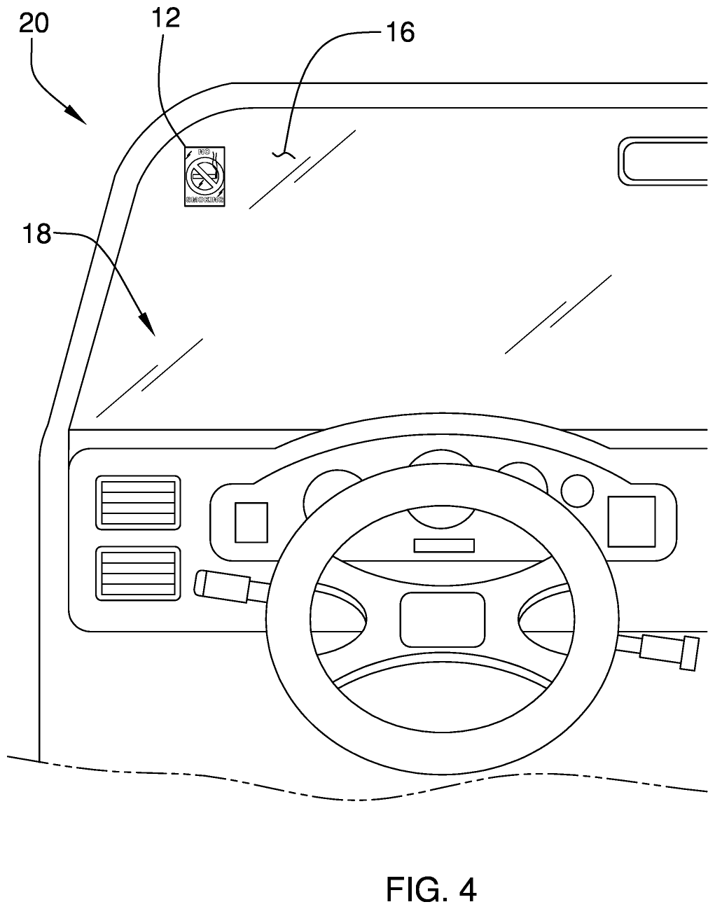

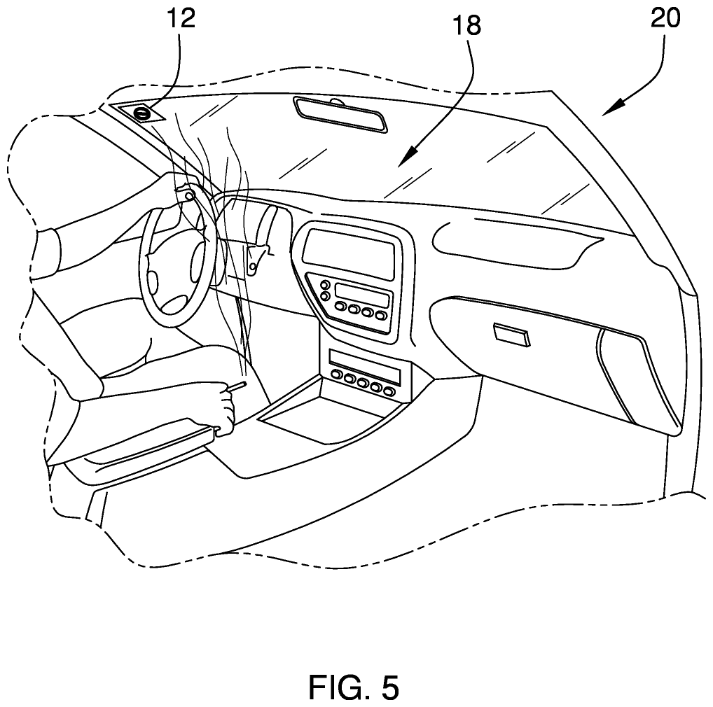

With reference now to the drawings, and in particular to FIGS. 1 through 5 thereof, a new detection device embodying the principles and concepts of an embodiment of the disclosure and generally designated by the reference numeral 10 will be described.

As best illustrated in FIGS. 1 through 5, the smoke detection assembly 10 generally comprises a decal 12 that has an adhesive layer 14 integrated thereon such that the decal 12 can be adhered to a windshield 16 in a cab 18 of a vehicle 20. The vehicle 20 may be a passenger vehicle a cargo vehicle or any other motorized vehicle that has an enclosed cab. Additionally, the vehicle 20 may be a rental vehicle that has been rented for temporary use. The decal 12 has a front surface 22 and a back surface 24, the adhesive layer 14 is positioned on the back surface 24, and the adhesive layer 14 completely covers the back surface 24.

The front surface 22 has image indicia 26 printed thereon and the image indicia 26 comprise an image of a prohibition symbol covering a burning cigarette. In this way the image indicia 26 can visually communicate that smoking in the vehicle 20 is forbidden. Additionally, the front surface 22 has word indicia 28 printed thereon and the word indicia 28 comprise the words “no smoking”. In this way the word indicia 28 can visually communicate that smoking in the vehicle 20 is forbidden. The front surface 22 has a border 30 extending fully around a perimeter edge of the decal 12. The border 30 is visually distinct with respect to the front surface 22 of the decal 12 and the border 30 surrounds both the image indicia 26 and the word indicia 28.

A chemical reagent 32 is provided and the chemical reagent 32 is infused into the decal 12. The chemical reagent 32 comprises a compound that is chemically reactive with one or more chemicals that are unique to smoke from combustion of organic material, including but not being limited to, organic material, marijuana or cocaine, such that the chemical reagent 32 changes colors when the chemical reagent 32 is exposed to airborne smoke. In this way the chemical reagent 32 can visually indicate when an organic material has been smoked in the vehicle 20. The chemical reagent 32 may be infused in each of the image indicia 26 and the word indicia 28 such that each of the image indicia 26 and the word indicia 28 change colors when the organic material is smoked in the vehicle 20.

A protective layer 34 is provided and the protective layer 34 is removably positioned on the adhesive layer 14. In this way the protective layer 34 inhibits the adhesive layer 14 from adhering to a windshield 16. The protective layer 34 completely covers an exposed windshield 16 of the adhesive layer 14. The adhesive layer 14 may comprise a single use adhesive that does not leave a residue behind thereby facilitating the decal 12 to be cleanly removed from the windshield 16 in the cab 18 of the vehicle 20.

In use, the protective layer 34 is removed from the adhesive layer 14 and the decal 12 is positioned in a conspicuous location in the cab 18 of the vehicle 20. Thus, the chemical reagent 32 in the decal 12 will be exposed to smoke when organic material is smoked in the vehicle 20. In this way the decal 12 can visually indicate when organic material has been smoked in a rental vehicle 20, for example. The decal 12 can thusly empower a rental agency to charge a penalty fee when organic material, or other substance, is smoked in a rental vehicle 20 they have supplied. The decal 12 is replaced once the chemical reagent 32 has been exposed to smoke.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A smoke detection assembly being positionable within a vehicle thereby facilitating a chemical reaction with cigarette smoke to produce a visual indication that a cigarette has been smoked in the vehicle, said assembly comprising:
a decal having an adhesive layer being integrated thereon wherein said decal is configured to be adhered to a surface in a cab of a vehicle; and
a chemical reagent being infused into said decal, said chemical reagent being chemically reactive with one or more chemicals being unique to smoke from combustion of an organic material such that said chemical reagent changes colors when said chemical reagent is exposed to airborne smoke wherein said chemical reagent is configured to visually indicate when organic material has been smoked in the vehicle.

2. The assembly according to claim 1, wherein said decal having a front surface and a back surface, said adhesive layer being positioned on said back surface, said adhesive layer completely covering said back surface.

3. The assembly according to claim 2, wherein said front surface has image indicia being printed thereon, said image indicia comprising an image of a prohibition symbol covering a burning cigarette wherein said indicia is configured to visually communicate that smoking organic material in the vehicle is forbidden.

4. The assembly according to claim 2, wherein said front surface has word indicia being printed thereon, said word indicia comprising the words “no smoking” wherein said word indicia is configured to visually communicate that smoking organic material in the vehicle is forbidden.

5. The assembly according to claim 2, wherein:
said front surface has image indicia being printed thereon;
said front surface has word indicia being printed thereon: and
said front surface has a border extending fully around a perimeter edge of said decal, said border being visually distinct with respect to said front surface of said decal, said border surrounding said image indicia and said word indicia.

6. The assembly according to claim 2, further comprising a protective layer being removably positioned on said adhesive layer to inhibit said adhesive layer from adhering to a surface, said protective layer completely covering an exposed surface of said adhesive layer.

7. A smoke detection assembly being positionable within a vehicle thereby facilitating a chemical reaction with cigarette smoke to produce a visual indication that a cigarette has been smoked in the vehicle, said assembly comprising:
a decal having an adhesive layer being integrated thereon wherein said decal is configured to be adhered to a surface in a cab of a vehicle, said decal having a front surface and a back surface, said adhesive layer being positioned on said back surface, said adhesive layer completely covering said back surface, said front surface having image indicia being printed thereon, said image indicia comprising an image of a prohibition symbol covering a burning cigarette wherein said indicia is configured to visually communicate that smoking organic material in the vehicle is forbidden, said front surface having word indicia being printed thereon, said word indicia comprising the words “no smoking” wherein said word indicia is configured to visually communicate that smoking organic material in the vehicle is forbidden, said front surface having a border extending fully around a perimeter edge of said decal, said border being visually distinct with respect to said front surface of said decal, said border surrounding said image indicia and said word indicia;
a chemical reagent being infused into said decal, said chemical reagent being chemically reactive with one or more chemicals being unique to smoke from combustion of organic material such that said chemical reagent changes colors when said chemical reagent is exposed to airborne smoke wherein said chemical reagent is configured to visually indicate when organic material has been smoked in the vehicle; and
a protective layer being removably positioned on said adhesive layer to inhibit said adhesive layer from adhering to a surface, said protective layer completely covering an exposed surface of said adhesive layer.

8. A method of detecting when organic material has been smoked in a vehicle, the steps of the method comprising:
providing a decal having an adhesive layer being integrated thereon wherein said decal is configured to be adhered to a surface in a cab of a vehicle;
printing indicia on said decal comprising imagery and words to communicate that smoking organic material in the vehicle is forbidden;
providing a chemical reagent being infused into said decal, said chemical reagent being chemically reactive with one or more chemicals being unique to smoke from combustion of organic material such that said chemical reagent changes colors when said chemical reagent is exposed to airborne nicotine wherein said chemical reagent is configured to visually indicate when organic material has been smoked in the vehicle; and
adhering said adhesive layer to a surface in the cab of the vehicle thereby facilitating said chemical reagent to be exposed to airborne nicotine when organic material is smoked in the vehicle.
